(19) United States
(12) Patent Application Publication
(10) Pub. No.: US 2012/0123852 A1
(43) Pub. Date: May 17, 2012

(54) METHOD AND SYSTEM FOR PROVIDING ADVERTISING EFFECT REPORT

(75) Inventor: Yoon Hyoung Noh, Seongnam-si (KR)

(73) Assignee: NHN BUSINESS PLATFORM CORPORATION, Seongnam-si (KR)

(21) Appl. No.: 13/124,473

(22) PCT Filed: Oct. 16, 2009
(86) PCT No.: PCT/KR2009/005982

§ 371 Date: Jul. 11, 2011

(30) Foreign Application Priority Data
Oct. 17, 2008 (KR) 10-2008-0101938

(51) Int. Cl. G06Q 30/02

(52) U.S. Cl. 705/14.41

(57) ABSTRACT

A system and method for providing an advertising effect report are provided. The method for providing an advertising effect report may include measuring an advertising effect of a search advertisement, storing an advertisement management history for the search advertisement, and providing the advertising effect in association with the advertisement management history.

### CROSS-REFERENCE TO RELATED APPLICATIONS

This application is the National Stage Entry of International Application PCT/KR2009/005982, filed on Oct. 16, 2009, and claims priority from and the benefit of Korean Patent Application No. 10-2008-0101938, filed on Oct. 17, 2008, both of which are incorporated herein by reference for all purposes as if fully set forth herein.

### BACKGROUND OF THE INVENTION

1. Field of the Invention

The present invention relates to an advertising system for providing a search advertising service, and more particularly, to a method and system for providing an advertising effect report that may more easily analyze an advertising effect of a search advertisement.

2. Discussion of the Background

A search advertising service enables a service user who enters a predetermined keyword in a search engine to be provided with advertisement information of an advertiser corresponding to the keyword.

The search advertising service may provide the advertiser with the advertisement information to be displayed in response to a search request from the service user, and may also enable connection between the service user and the advertiser through a click of the service user on the displayed advertisement information. Accordingly, the search advertising service has been adopted as a new advertising means.

An advertiser may perform purchasing and registering a search advertisement associated with a predetermined keyword. The advertiser may purchase a specific keyword from a search engine that provides a search advertising service, may enter advertisement information including uniform resource locator (URL) information to be displayed on a predetermined advertising area, and may register a search advertisement associated with a corresponding keyword.

An operator of the search advertising service may charge predetermined advertising costs to the advertiser, as a compensation concept for connection between the service user and the advertiser based on clicks of the service user. Additionally, the operator may enable the charged advertising costs to be deducted from a predetermined account of the advertiser.

Therefore, the operator of the search advertising service needs to accurately measure an advertising effect of the search advertisement registered by the advertiser, and to report the measured advertising effect to the advertiser so that the advertiser may effectively analyze the advertising effect of the registered search advertisement and may estimate appropriate advertising costs.

### SUMMARY OF THE INVENTION

The present invention provides a method and system for providing an advertising effect report that may effectively display an advertisement management history having an influence on an advertising effect of a search advertisement.

The present invention also provides a method and system for providing an advertising effect report that may easily compare and analyze an advertising result before and after an action for advertisement management of a search advertisement.

In the case of a search advertisement, an operation, such as editing of a copy and modifying of a bid, may be performed by an advertiser with respect to an advertisement, and the advertiser needs to see what result is obtained by actions performed by the advertiser. Accordingly, the present invention also provides a method and system for providing an advertising effect report that may display and provide such an action of the advertiser on the advertising effect report, thereby supporting decision making of advertisers with greater convenience.

An exemplary embodiment of the present invention discloses a method for providing an advertising effect report, the method including: measuring an advertising effect of a search advertisement; storing an advertisement management history for the search advertisement; and providing the advertising effect in association with the advertisement management history.

Here, the advertisement management history may include at least one of an event to manage the search advertisement, or a page address associated with the event. The event may be an action of an advertiser with respect to the search advertisement, and may include at least one of editing of an advertising copy, setting of a budget, setting of a day strategy, or modifying of a bid.

Additionally, the providing may include providing a graph that represents a change in the advertising effect, and displaying, on the graph, an event marker corresponding to the event. Here, the event marker may include at least one of a function of displaying details of the event, and a function of moving to a page associated with the event.

An exemplary embodiment of the present invention discloses a system for providing an advertising effect report, the system including: an advertising effect measuring unit to measure an advertising effect of a search advertisement; a history storage unit to store an advertisement management history for the search advertisement; and an advertising effect providing unit to provide the advertising effect in association with the advertisement management history.

According to the present invention, an advertisement management history may be displayed together with an advertising effect of the search advertisement, and thus it is possible to improve reliability of an advertiser based on an advertising effect report with a new form for easily analyzing an advertising result before and after an action for advertisement management.

### BRIEF DESCRIPTION OF THE DRAWINGS

FIG. 1 is a diagram illustrating a network configuration associated with an advertising effect report providing system according to embodiments of the present invention.

FIG. 2 is a diagram illustrating a configuration of the advertising effect report providing system according to embodiments of the present invention.

FIG. 3 is a flowchart illustrating an advertising effect report providing method according to embodiments of the present invention.

FIG. 4 is a diagram illustrating an event list for display on an advertising effect report.

FIG. 5 is a diagram illustrating an example of an advertising effect report displayed together with an event.

FIG. 6 is a diagram illustrating an example of an advertising effect report based on various display criteria.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

Hereinafter, a method and system for providing an advertising effect report according to the present invention will be described with reference to the accompanying drawings.

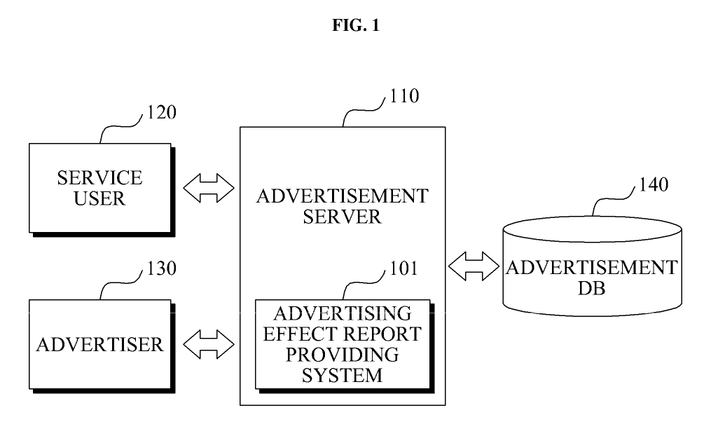

FIG. 1 illustrates a diagram of a network configuration associated with an advertising effect report providing system according to embodiments of the present invention.

Referring to FIG. 1, an advertisement server 110 may run a website that provides a search advertising service, and may function as a search engine to support a search operation so as to facilitate a connection to a web page containing content that a service user 120 desires to search for. The advertisement server 110 may provide advertisement information related to an advertiser 130, in response to a search request of the service user 120. Here, the advertisement information may include information requested by the service user 120.

The advertiser 130 may purchase a specific keyword in the advertisement server 110, may enter advertisement information including uniform resource locator (URL) information to be displayed on a predetermined advertising area, to register a search advertisement for a corresponding keyword.

The advertisement database (DB) 140 may be a memory device to connect advertisement information for each advertiser and store the advertisement information. The advertisement DB 140 may function to register and store advertisement information based on a keyword, for a search advertising service.

The advertisement server 110 may measure an advertising effect of a registered search advertisement, and may report the measured advertising effect to the advertiser 130. In other words, the advertisement server 110 may include an advertising effect report providing system 101 to generate an advertising effect report regarding the search advertisement and to provide the advertiser 130 with the advertising effect report.

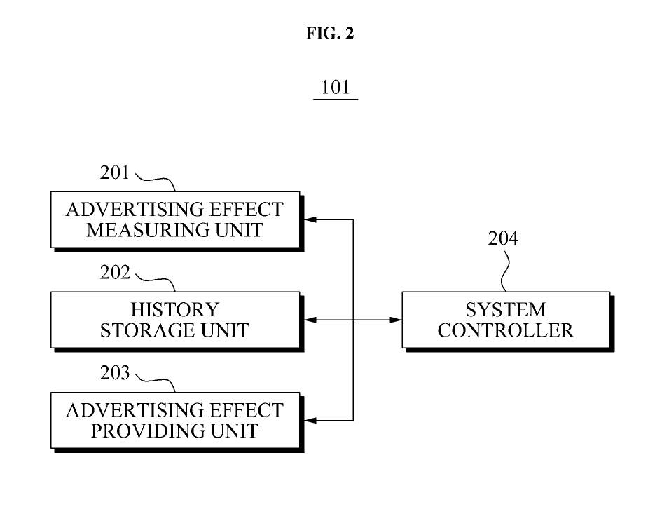

FIG. 2 illustrates a block diagram of an example of the advertising effect report providing system 101.

Referring to FIG. 2, the advertising effect report providing system 101 may include an advertising effect measuring unit 201, a history storage unit 202, an advertising effect providing unit 203, and a system controller 204.

The advertising effect measuring unit 201 may function to measure an advertising effect of a search advertisement registered by an advertiser. Specifically, for example, the advertising effect measuring unit 201 may measure, as the advertising effect, a number of impressions of the search advertisement, a number of clicks of the search advertisement, a click-through rate (CTR) of the number of clicks with respect to the number of impressions. The advertising effect measuring unit 201 may measure the advertising effect of the search advertisement, at regular intervals, for example, every 24 hours.

The history storage unit 202 may function to store an advertisement management history for the registered search advertisement. Here, the advertisement management history may include, for example, an event to manage the search advertisement, a page address associated with the event.

In the present specification, an “event” may be an action of an advertiser with respect to a search advertisement, and in particular, may refer to an advertisement management action that has an influence on the advertising effect. The event may include, for example, editing of an advertising copy, setting of an advertising expense budget, setting of a day strategy, modifying of a bid, and setting of an impression area. Table 1 shows examples of the type of event below. An event name and details in Table 1 are merely examples and accordingly, it is obvious that the present invention is not limited thereto.

TABLE 1

| Event name | Details |
|---|---|
| Edit copy | Edit a title, a copy and an URL of an |
| | advertisement, and the like |
| Modify bid | Adjust a bid for an advertisement |
| Change impression area | Change setting of an advertisement |
| | impression area of a keyword group |
| Change setting of budget | Change setting of a budget limit of a |
| | keyword group |

The advertising effect providing unit 203 may function to provide the measured advertising effect in association with an advertisement management history for a corresponding search advertisement, that is, in association with an event. The advertising effect providing unit 203 may represent a change in the advertising effect using a graph, and may display, on the graph, an event marker corresponding to the event. The advertising effect providing unit 203 may configure the event marker with an icon, and may trace details of the corresponding event using the event marker. Table 2 shows examples of data for displaying an event marker below.

TABLE 2

| | | | | | |
|---|---|---|---|---|---|
| Date of | May 21, 2008 | May 22, 2008 | May 23, 2008 | May 24, 2008 | May 25, 2008 |
| occurrence | | | | | |
| Number of | 10000 | 12000 | 13000 | 11000 | 9000 |
| impressions | | | | | |
| Number of | 40 | 52 | 63 | 60 | 40 |
| clicks | | | | | |
| CTR | 0.40% | 0.43% | 0.48% | 0.55% | 0.44% |
| Event name | | Edit copy | | | |
| Link | | http://xxx.xxx.xxx | | | |
| Marker color | | Red | | | |

As shown in Table 2, to display the event marker, information such as a date of occurrence, an event name, and a link and a marker color with respect to the event may be required. Although not shown in Table 2, when a plurality of events occur at the same date, a priority may be set for each of the events, and an order of the events to be displayed on the graph may be determined.

The system controller 204 may be configured to control an overall operation of the advertising effect report providing system 101. In other words, for example, the system controller 204 may control operations of the advertising effect measuring unit 201, the history storage unit 202, and the advertising effect providing unit 203.

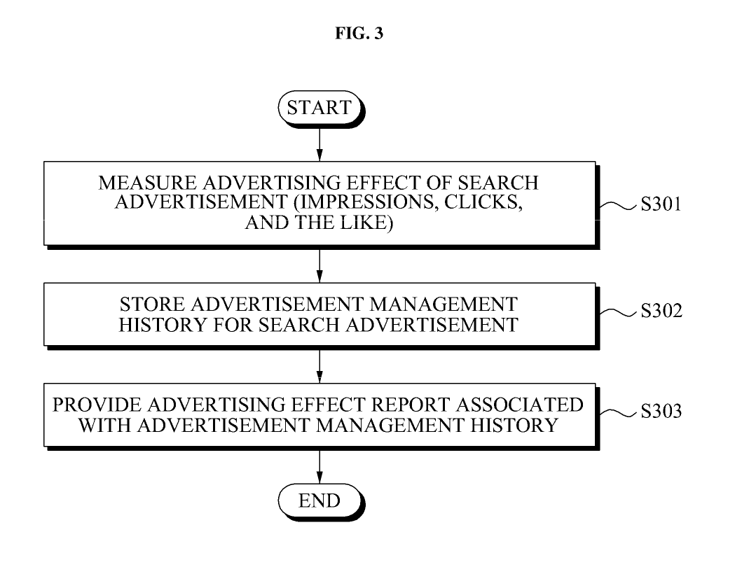

FIG. 3 illustrates a flowchart of an advertising effect report providing method according to embodiments of the present invention.

Referring to FIG. 3, the advertising effect report providing method may include the following operations.

In operation S301, an advertising effect report providing system may be configured to measure an advertising effect of a search advertisement of an advertiser. Here, the advertising effect may include, for example, a number of impressions of the search advertisement, a number of clicks of the search advertisement, a CTR of the number of clicks with respect to the number of impressions. The advertising effect may be measured at regular intervals, for example, every 24 hours.

In operation S302, the advertising effect report providing system may be configured to store and manage an advertisement management history for the search advertisement. Here, the advertisement management history may include, for example, an event to manage the search advertisement, a page address associated with the event. The event may be an advertisement management action that has an influence on the advertising effect, and may include, for example, editing of an advertising copy, setting of an advertising expense budget, setting of a day strategy, modifying of a bid, and setting of an impression area.

The advertising effect report providing system may store the advertisement management history upon occurrence of an event in an event list that is defined in advance with respect to the search advertisement.

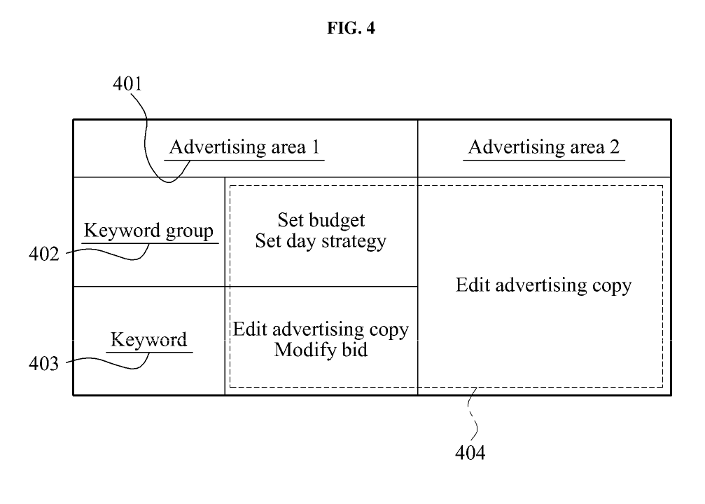

FIG. 4 illustrates a diagram of an event list for display on an advertising effect report.

Referring to FIG. 4, in the event list, an event 404 desired to be displayed together with the measured advertising effect may be designated in advance. The event list may be designated for each unit of at least one of an advertising area 401, a keyword group 402, and a keyword 403.

The advertising effect report providing system may store the advertisement management history for each date, for each hour, for each minute, and for each second. In particular, when at least one event occurs at the same time, the advertising effect report providing system may store an advertisement management history for an event occurring at a specific time, for example, an event occurring at the end of the day.

In operation S303, the advertising effect report providing system may provide the advertising effect measured in operation S301, in association with the advertisement management history of the corresponding search advertisement, that is, in association with an event.

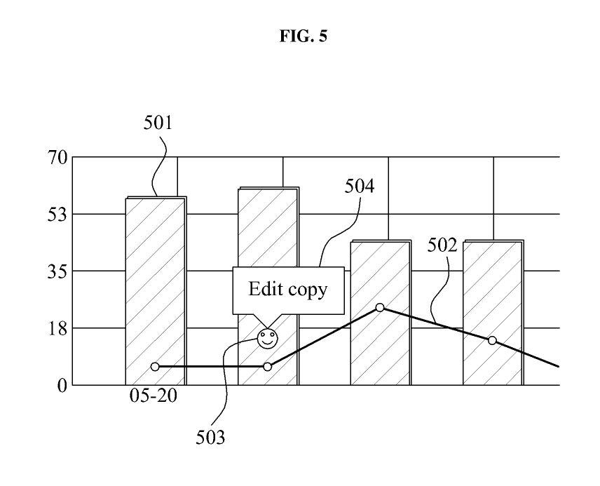

FIG. 5 illustrates a diagram of an example of an advertising effect report provided to an advertiser.

Referring to FIG. 5, the advertising effect report providing system may represent a change in the advertising effect using a graph, and may display, on the graph, an event marker corresponding to the event.

For example, the advertising effect report may provide an impression-based graph 501 indicating a change in a number of impressions, together with a click-based graph 502 indicating a change in a number of clicks. In this example, an event marker 503 may be displayed on a location of the impression-based graph 501 and click-based graph 502 that corresponds to a time that a corresponding event occurs.

The advertising effect report providing system may configure the event marker with an icon including a trace function of tracing details of a corresponding event, and may provide the event marker.

Referring to FIG. 5, when a cursor moves to a location of the event marker 503, the advertising effect report providing system may provide a function of launching a text window 504 such as a word balloon function, and of displaying details of the corresponding event (for example, “editing of an advertising copy”) through the text window 504. Additionally, when the event marker 503 is clicked on, the advertising effect report providing system may provide a function of moving to a page associated with the corresponding event. For example, as described with reference to Table 2, when a link related to the event marker 503 is stored, and when the event marker 503 is clicked on, a function of moving to the linked page may be provided. The page associated with the event may refer to a page where an advertiser performs an advertisement management action for the search advertisement, and in particular, may refer to a page enabling an advertisement management action corresponding to a corresponding event.

Additionally, the advertising effect report providing system may provide the change in the advertising effect for each unit of at least one of an advertising area, a keyword group, and a keyword with respect to the search advertisement.

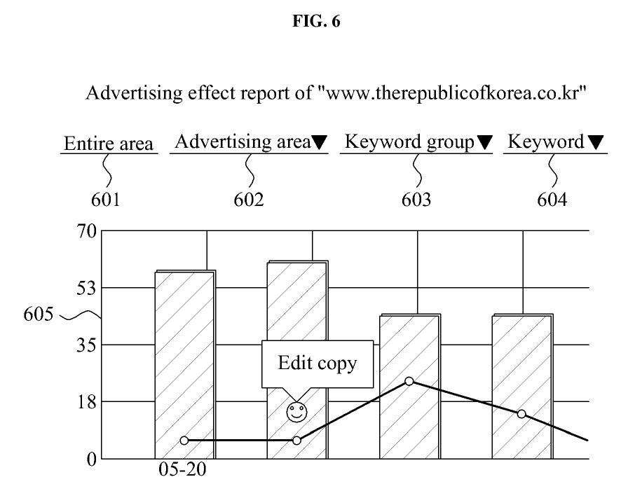

FIG. 6 is a diagram illustrating an example of an advertising effect report based on various display criteria.

Referring to FIG. 6, the advertising effect report providing system may measure an advertising effect for an entire area 601 of the search advertisement, or may measure an advertising effect for a unit of at least one of an advertising area 602, a keyword group 603, and a keyword 604. Additionally, the advertising effect report providing system may provide an advertising effect graph 605, together with an advertisement management history. In other words, a menu may be formed so as to enable a selection of an advertiser, and a change in the advertising effect of the search advertisement may be provided, based on the selection of the advertiser, for the entire area 601, or for each unit of at least one of the advertising area 602, the keyword group 603, and the keyword 604.

Thus, the advertising effect report providing system may display, on a graph representing the advertising effect, the advertising effect in association with the advertisement management history that has an influence on the advertising effect. Accordingly, it is possible to more easily compare and analyze the advertising effect before and after an event, namely, an advertisement management action of an advertiser.

The advertising effect report providing method according to the present invention may be recorded in computer-readable media including program instructions to implement various operations embodied by a computer. The media may also include, alone or in combination with the program instructions, for example, data files and data structures. The program instructions recorded on the media may be those specially designed and constructed for the purposes of the example embodiments, or they may be of the kind well-known and available to those having skill in the computer software arts. Examples of computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), and flash memory. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method for providing an advertising effect report of a search advertising, the method comprising:
determining an advertising effect of a search advertisement;
receiving and storing an advertisement management history for the search advertising; and
providing the advertising effect report in association with the advertisement management history.

2. The method of claim 1, wherein the determining comprises measuring, as the advertising effect, a number of impressions, a number of clicks, a rate of the number of clicks, or any combination thereof with respect to the number of impressions.

3. The method of claim 1, wherein the advertisement management history comprises an event to manage the search advertisement, a page address, or both the event ad the page address associated with the event.

4. The method of claim 3, wherein the event comprises an action of an advertiser with respect to the search advertisement, and corresponds to editing of an advertising copy, setting of a budget, setting of a day strategy, modifying of a bid, setting of an impression area, or any combination thereof.

5. The method of claim 3, wherein the storing comprises defining an event list, and storing an advertisement management history for an event in the event list upon an occurrence of the event.

6. The method of claim 5, wherein the event list is defined for each unit of an advertising area, a keyword group, a keyword, or any combination thereof.

7. The method of claim 3, wherein the storing comprises storing the advertisement management history for each time.

8. The method of claim 7, wherein the storing comprises storing an advertisement management history for an event occurring at a specific time when multiple events occur at the same time.

9. The method of claim 3, wherein the providing comprises providing a graph and displaying an event marker corresponding to the event, the graph representing a change in the advertising effect.

10. The method of claim 9, wherein the providing comprises displaying the event marker on a location corresponding to a time that the event occurs.

11. The method of claim 9, wherein the providing comprises configuring the event marker with an icon having a trace function of tracing details of the event.

12. The method of claim 11, wherein the trace function comprises a function of displaying the details of the event when a cursor moves to a location of the event marker, a function of moving to a page associated with the event when the event marker is clicked on, or both the function of displaying the details of the event and the function of moving to a page associated with the event.

13. The method of claim 9, wherein the providing comprises providing the change in the advertising effect for each unit of an advertising area, a keyword group, a keyword, or any combination thereof.

14. A non-transitory computer readable recording medium comprising an executable program, which when executed, performs the method of claim 1.

15. A system for providing an advertising effect report of a search advertising, the system comprising:
an advertising effect measuring unit to determine an advertising effect of a search advertisement;
a history storage unit to receive and store an advertisement management history for the search advertising; and
an advertising effect providing unit to provide the advertising effect report in association with the advertisement management history.

16. The system of claim 15, wherein the advertising effect measuring unit is configured to determine, as the advertising effect, a number of impressions, a number of clicks, a rate of the number of clicks, or any combination thereof with respect to the number of impressions.

17. The system of claim 15, wherein the advertisement management history comprises an event to manage the search advertisement, a page address associated with the event, or both the event and the gage address.

18. The system of claim 17, wherein the event comprises an action of an advertiser with respect to the search advertisement, and corresponds to editing of an advertising copy, setting of a budget, setting of a day strategy, modifying of a bid, or any combination thereof.

19. The system of claim 17, wherein the history storage unit is configured to define an event list, and to store an advertisement management history for an event in the event list upon an occurrence of the event.

20. The system of claim 19, wherein the event list is defined for each unit of an advertising area, a keyword group, a keyword, or any combination thereof.

21. The system of claim 17, wherein the history storage unit is configured to store the advertisement management history for each time.

22. The system of claim 21, wherein the history storage unit is configured to store an advertisement management history for a last event when multiple events occur at the same time.

23. The system of claim 17, wherein the advertising effect providing unit is configured to provide a graph representing a change in the advertising effect, and displays, on the graph, an event marker corresponding to the event.

24. The system of claim 23, wherein the advertising effect providing unit is configured to display the event marker on a location corresponding to a time that the event occurs.

25. The system of claim 23, wherein the advertising effect providing unit is configured to configure the event marker with an icon having a trace function of tracing details of the event.

26. The system of claim 25, wherein the trace function comprises a function of displaying the details of the event when a cursor moves to a location of the event marker, a function of moving to a page associated with the event when the event marker is clicked on, or the both of the functions.

27. The system of claim 23, wherein the advertising effect providing unit is configured to provide the change in the advertising effect for each unit of an advertising area, a keyword group, a keyword, or any combination thereof.
